(19) United States
(12) Patent Application Publication
(10) Pub. No.: US 2025/0097099 A1
(43) Pub. Date: Mar. 20, 2025

(54) COMMUNICATION METHOD AND APPARATUS

(71) Applicant: HUAWEI TECHNOLOGIES CO., LTD., Shenzhen (CN)

(72) Inventors: Shaoyun PAN, Shanghai (CN); Weijun XING, Shanghai (CN)

(21) Appl. No.: 18/966,762

(22) Filed: Dec. 3, 2024

Related U.S. Application Data
(63) Continuation of application No. PCT/CN2023/098827, filed on Jun. 7, 2023.

(30) Foreign Application Priority Data
Jun. 16, 2022 (CN) 202210679947.4

(51) Int. Cl. H04L 41/0803

(52) U.S. Cl. CPC H04L 41/0803

(57) ABSTRACT

A communication method includes sending, by a first network device, a first configuration request message to a second network device, and receiving, by the first network device, a first configuration response message from the second network device. The first configuration request message is useable to configure a management and control operation of the second network device. The first network device is a core network device configured to control a network function. The second network device is the core network device configured to process at least one of a user plane function or a control plane function. The first configuration response message includes a first response result of the second network device for the management and control operation.

### CROSS-REFERENCE TO RELATED APPLICATIONS

This application is a continuation of International Application No. PCT/CN2023/098827, filed on Jun. 7, 2023, which claims priority to Chinese Patent Application No. 202210679947.4, filed on Jun. 16, 2022, the disclosures of the aforementioned applications are hereby incorporated by reference in their entireties.

### TECHNICAL FIELD

This application relates to the communication field, and in particular, to a communication method and apparatus.

### BACKGROUND

Currently, there are a plurality of network functions (NF) in a core network (CN), and these NFs are all controlled by an operator. Some NFs have a function of performing processing by using a network as an object, for example, network-level access, network-level computing, or a network-level policy. Some NFs have a function of performing processing by using a user as an object, for example, user mobility management, user session management, user policy management, or user data forwarding. Some NFs have both a function of performing processing by using a network as an object and a function of performing processing by using a user as an object.

Depending on whether a processing object is a network or a user, nodes that execute these NFs may be classified into a node that implements a network processing function and a node that implements a user processing function. The node that implements the network processing function may also be referred to as a network service node (NSN), and the node that implements the user processing function may also be referred to as a user service node (USN). A node that performs processing by using both a network and a user as objects may be split into an NSN and a USN. For example, an access and mobility management function (AMF) network element has both an access management (AM) function (belonging to a network processing function) and a mobility management (MM) function (belonging to a user processing function). The AMF network element may be split into an NSN that implements the AM function and a USN that implements the MM function.

When the network processing function is separated from the user processing function, the NSN may be controlled by an operator, and the USN may be controlled by an integrator or a user. It can be learned that the manner in which the network processing function is separated from the user processing function may provide a specific sovereign control capability for the integrator or the user, so that adaptability of a network to the industry can be enhanced. When the network processing function is separated from the user processing function, how to configure the USN is an urgent problem to be resolved.

### SUMMARY

One or more embodiments of the present application provide a communication method and apparatus, so that a node responsible for a user processing function can be configured when a network processing function is separated from the user processing function.

According to a first aspect, an embodiment of this application provides a communication method. The method includes: a first network device sends a first configuration request message to a second network device, where the first configuration request message is used to configure a management and control operation of the second network device, where the first network device is a core network device configured to control a network function; and the second network device is a core network device configured to process a user plane function and/or a control plane function; and the first network device receives a first configuration response message from the second network device, where the first configuration response message includes a response result of the second network device for the management and control operation. It can be learned that, in the method, the core network device configured to control the network function can configure the core network device configured to process the user plane function and/or the control plane function.

In some embodiments, the core network device configured to control the network function may be a node responsible for a network processing function, and the core network device configured to process the user plane function and/or the control plane function may be a node responsible for a user processing function. The method can support an architecture in which the network processing function is separated from the user processing function. Therefore, when the network processing function is separated from the user processing function, the node responsible for the network processing function can configure the node responsible for the user processing function, thereby reducing complexity and an error rate of manual configuration.

In some embodiments, the first network device is configured to maintain a topology relationship of a core network device. Before the first network device sends the first configuration request message to the second network device, the method further includes: the first network device determines the second network device and the first configuration request message based on a running status of the core network device in the topology relationship. Optionally, in addition to being maintained by the first network device, the topology relationship of the core network device may be alternatively obtained by the first network device from another device such as a network repository function (network repository function, NRF) or a network management system.

In some embodiments, the first configuration request message is used to configure a flow control operation of the second network device; and the first configuration response message includes a response result of the second network device for the flow control operation. It can be learned that the first network device can configure the second network device to perform flow control processing.

In some embodiments, the first configuration request message is used to configure a backup operation of the second network device for a user context of a third network device; the first configuration response message includes a response result of the second network device for the backup operation; and the third network device is a core network device configured to process a user plane function and/or a control plane function. It can be learned that the first network device can configure the second network device to back up the user context of the third network device.

According to a second aspect, an embodiment of this application provides a communication method. The method includes: a second network device receives a first configuration request message from a first network device, where the first configuration request message is used to configure a management and control operation of the second network device, where the first network device is a core network device configured to control a network function; and the second network device is a core network device configured to process a user plane function and/or a control plane function; and the second network device sends a first configuration response message to the first network device, where the first configuration response message includes a response result of the second network device for the management and control operation. It can be learned that, in the method, the core network device configured to process the user plane function and/or the control plane function can be configured by the core network device configured to control the network function.

In some embodiments, the core network device configured to control the network function may be a node responsible for a network processing function, and the core network device configured to process the user plane function and/or the control plane function may be a node responsible for a user processing function. The method can support an architecture in which the network processing function is separated from the user processing function. Therefore, when the network processing function is separated from the user processing function, the node responsible for the user processing function can be configured by the node responsible for the network processing function, thereby reducing complexity and an error rate of manual configuration.

In some embodiments, the first configuration response message is determined by the second network device based on the first configuration request message and a first message from a fourth network device or a network management system; the first message is used to configure a management and control operation of the second network device, and a type of the management and control operation configured by using the first message is the same as a type of the management and control operation configured by using the first configuration request message; and the fourth network device is a radio access network device configured to provide a communication connection function between a terminal and a core network.

It can be learned that a configuration of the radio access network device or the network management system for the second network device is also retained when the second network device is configured by the first network device. When the first network device is a node responsible for a network processing function and the second network device is a node responsible for a user processing function, user-level processing of the radio access network device or the network management system for the node responsible for the user processing function is also retained when the node responsible for the network processing function performs network-level processing on the node responsible for the user processing function. In this case, the node responsible for the user processing function can determine the first configuration response message with reference to a network-level configuration and a user-level configuration.

Optionally, a priority of the first configuration request message is higher than a priority of the first message, and the response result is an acknowledgment of the second network device for the management and control operation configured by using the first configuration request message. In this implementation, when the first network device is a node responsible for a network processing function and the second network device is a node responsible for a user processing function, a priority of a configuration of the node responsible for the network processing function for the node responsible for the user processing function is higher than a priority of the configuration of the radio access network device or the network management system for the node responsible for the user processing function, so that the network-level processing has a high-priority operation right on a premise that the user-level processing is retained.

In some embodiments, the first configuration request message is used to configure a flow control operation of the second network device; and the first configuration response message includes a response result of the second network device for the flow control operation. It can be learned that the second network device can be controlled by the first network device to perform flow control.

In some embodiments, the first configuration request message is used to configure a backup operation of the second network device for a user context of a third network device; the first configuration response message includes a response result of the second network device for the backup operation; and the third network device is a core network device configured to process a user plane function and/or a control plane function. It can be learned that the second network device can be controlled by the first network device to back up the user context of the third network device.

According to a third aspect, an embodiment of this application provides a communication method. The method includes: a first network device sends a second configuration request message to a fifth network device or a sixth network device, where the second configuration request message is used to configure a management and control operation of the sixth network device, where the first network device is a core network device configured to control a network function; the fifth network device is a core network device configured to process a user plane function and/or a control plane function; and the sixth network device is a radio access network device configured to provide a communication connection function between a terminal and a core network; and the first network device receives a second configuration response message from the fifth network device or the sixth network device, where the second configuration response message includes a response result of the sixth network device for the management and control operation. It can be learned that, in the method, the core network device configured to control the network function can directly configure the radio access network device, or the core network device configured to control the network function can indirectly configure the radio access network device through the core network device that processes the user plane function and/or the control plane function.

In some embodiments, the core network device configured to control the network function may be a node responsible for a network processing function, and the core network device configured to process the user plane function and/or the control plane function may be a node responsible for a user processing function. The method can support an architecture in which the network processing function is separated from the user processing function. Therefore, when the network processing function is separated from the user processing function, the node responsible for the network processing function can directly configure the radio access network device, or the node responsible for the network processing function can indirectly configure the radio access network device through the node responsible for the user processing function, thereby implementing a real-time or quasi-real-time collaborative closed-loop between the core network and a radio access network, and also reducing complexity and an error rate of manual configuration.

In some embodiments, the first network device is configured to maintain a topology relationship of a core network device and/or a topology relationship of a radio access network device. Before the first network device sends the second configuration request message to the fifth network device or the sixth network device, the method further includes: the first network device determines the fifth network device and/or the sixth network device and the second configuration request message based on a running status of the core network device in the topology relationship and/or a running status of the radio access network device in the topology relationship. Optionally, in addition to being maintained by the first network device, the topology relationship of the core network device and/or the topology relationship of the radio access network device may be alternatively obtained by the first network device from another device such as an NRF or a network management system.

In some embodiments, the second configuration request message is used to configure a flow control operation of the sixth network device; and the second configuration response message includes a response result of the sixth network device for the flow control operation. It can be learned that the first network device can configure the sixth network device to perform flow control.

In some embodiments, the second configuration request message is used to configure a storage operation of the sixth network device for a backup relationship between a seventh network device and an eighth network device; the second configuration response message includes a response result of the sixth network device for the storage operation; and the seventh network device and the eighth network device are core network devices that are connected to the sixth network device and that are configured to process a user plane function and/or a control plane function. It can be learned that the first network device can configure the sixth network device to store the backup relationship.

According to a fourth aspect, an embodiment of this application provides a communication method. The method includes: a sixth network device receives a second configuration request message from a first network device, or a sixth network device receives a second configuration request message from a first network device that is forwarded by a fifth network device, where the second configuration request message is used to configure a management and control operation of the sixth network device, where the first network device is a core network device configured to control a network function; the fifth network device is a core network device configured to process a user plane function and/or a control plane function; and the sixth network device is a radio access network device configured to provide a communication connection function between a terminal and a core network; and the sixth network device sends a second configuration response message to the first network device or the fifth network device, where the second configuration response message includes a response result of the sixth network device for the management and control operation. It can be learned that, in the method, the radio access network device can be directly configured by the core network device configured to control the network function, or can be indirectly configured, through the core network device that processes the user plane function and/or the control plane function, by the core network device configured to control the network function.

In some embodiments, the core network device configured to control the network function may be a node responsible for a network processing function, and the core network device configured to process the user plane function and/or the control plane function may be a node responsible for a user processing function. The method can support an architecture in which the network processing function is separated from the user processing function. Therefore, when the network processing function is separated from the user processing function, the radio access network device can be directly configured by the node responsible for the network processing function, or can be indirectly configured, through the node responsible for the user processing function, by the node responsible for the network processing function, thereby implementing a real-time or quasi-real-time collaborative closed-loop between the core network and a radio access network, and also reducing complexity and an error rate of manual configuration.

In some embodiments, the second configuration response message is determined by the sixth network device based on the second configuration request message and a second message from a ninth network device or a network management system; the second message is used to configure a management and control operation of the sixth network device, and a type of the management and control operation configured by using the second message is the same as a type of the management and control operation configured by using the second configuration request message; and the ninth network device is a core network device configured to process a user plane function and/or a control plane function.

It can be learned that a configuration of the ninth network device or the network management system for the sixth network device is also retained when the sixth network device is configured by the first network device. When the first network device is a node responsible for a network processing function and the ninth network device is a node responsible for a user processing function, user-level processing of the node responsible for the user processing function or the network management system for the radio access network device is also retained when network-level processing is performed on the radio access network device by the node responsible for the network processing function. In this case, the radio access network device can determine the second configuration response message with reference to a network-level configuration and a user-level configuration.

In some embodiments, a priority of the second configuration request message is higher than a priority of the second message, and the response result is an acknowledgment of the sixth network device for the management and control operation configured by using the second configuration request message. In this implementation, when the first network device is a node responsible for a network processing function and the ninth network device is a node responsible for a user processing function, a priority of a configuration of the node responsible for the network processing function for the radio access network device is higher than a priority of the configuration of the node responsible for the user processing function or the network management system for the radio access network device, so that the network-level processing has a high-priority operation right on a premise that the user-level processing is retained.

In some embodiments, the second configuration request message is used to configure a flow control operation of the sixth network device; and the second configuration response message includes a response result of the sixth network device for the flow control operation. It can be learned that the sixth network device can be controlled by the first network device to perform flow control.

In some embodiments, the second configuration request message is used to configure a storage operation of the sixth network device for a backup relationship between a seventh network device and an eighth network device; the second configuration response message includes a response result of the sixth network device for the storage operation; and the seventh network device and the eighth network device are core network devices that are connected to the sixth network device and that are configured to process a user plane function and/or a control plane function.

According to a fifth aspect, an embodiment of this application provides a communication method. The method includes: a fifth network device receives a second configuration request message from a first network device, where the second configuration request message is used to configure a management and control operation of a sixth network device; the fifth network device sends the second configuration request message to the sixth network device; the fifth network device receives a second configuration response message from the sixth network device, where the second configuration response message includes a response result of the sixth network device for the management and control operation; and the fifth network device sends the second configuration response message to the first network device, where the first network device is a core network device configured to control a network function; the fifth network device is a core network device configured to process a user plane function and/or a control plane function; and the sixth network device is a radio access network device configured to provide a communication connection function between a terminal and a core network. It can be learned that the method helps the core network device configured to control the network function indirectly configure the radio access network device through the core network device that processes the user plane function and/or the control plane function.

In some embodiments, the core network device configured to control the network function may be a node responsible for a network processing function, and the core network device configured to process the user plane function and/or the control plane function may be a node responsible for a user processing function. It can be learned that the method can support an architecture in which the network processing function is separated from the user processing function. Therefore, when the network processing function is separated from the user processing function, the node responsible for the network processing function can indirectly configure the radio access network device through the node responsible for the user processing function, thereby implementing a real-time or quasi-real-time collaborative closed-loop between the core network and a radio access network, and also reducing complexity and an error rate of manual configuration.

In some embodiments, the second configuration request message is used to configure a flow control operation of the sixth network device; and the second configuration response message includes a response result of the sixth network device for the flow control operation. This manner helps the first network device indirectly configure, through the fifth network device, the sixth network device to perform flow control.

In some embodiments, the second configuration request message is used to configure a storage operation of the sixth network device for a backup relationship between a seventh network device and an eighth network device; the second configuration response message includes a response result of the sixth network device for the storage operation; and the seventh network device and the eighth network device are core network devices that are connected to the sixth network device and that are configured to process a user plane function and/or a control plane function.

According to a sixth aspect, this application further provides a communication apparatus. The communication apparatus has a function of implementing some or all of the function implementations in any one of the first aspect to the fifth aspect. The function may be implemented by using hardware, or may be implemented by using hardware executing corresponding software. The hardware or the software includes at least one unit or module corresponding to the foregoing function.

In some embodiments, a structure of the communication apparatus may include a processing unit and a communication unit. The processing unit is configured to support the communication apparatus in performing a corresponding function in the foregoing methods. The communication unit is configured to support communication between the communication apparatus and another communication apparatus. The communication apparatus may further include a storage unit. The storage unit is configured to be coupled to the processing unit and the communication unit, and stores program instructions and data that are necessary for the communication apparatus. Optionally, the processing unit may be configured to control the communication unit to receive and send data/signaling.

In some embodiments, the communication unit is configured to send a first configuration request message to a second network device, where the first configuration request message is used to configure a management and control operation of the second network device, where the communication apparatus is a core network device configured to control a network function; the second network device is a core network device configured to process a user plane function and/or a control plane function; and the communication unit is further configured to receive a first configuration response message from the second network device, where the first configuration response message includes a response result of the second network device for the management and control operation.

In addition, for another optional implementation of the communication apparatus in this aspect, refer to related content of the first aspect. Details are not described herein again.

In some embodiments, the communication unit is configured to receive a first configuration request message from a first network device, where the first configuration request message is used to configure a management and control operation of the communication apparatus, where the first network device is a core network device configured to control a network function; the communication apparatus is a core network device configured to process a user plane function and/or a control plane function; and the communication unit is further configured to send a first configuration response message to the first network device, where the first configuration response message includes a response result of the communication apparatus for the management and control operation.

In addition, for another optional implementation of the communication apparatus in this aspect, refer to related content of the second aspect. Details are not described herein again.

In some embodiments, the communication unit is configured to send a second configuration request message to a fifth network device or a sixth network device, where the second configuration request message is used to configure a management and control operation of the sixth network device, where the communication apparatus is a core network device configured to control a network function; the fifth network device is a core network device configured to process a user plane function and/or a control plane function; the sixth network device is a radio access network device configured to provide a communication connection function between a terminal and a core network; and the communication unit is further configured to receive a second configuration response message from the fifth network device or the sixth network device, where the second configuration response message includes a response result of the sixth network device for the management and control operation.

In addition, for another optional implementation of the communication apparatus in this aspect, refer to related content of the third aspect. Details are not described herein again.

In some embodiments, the communication unit is configured to receive a second configuration request message from a first network device, or receive a second configuration request message from a first network device that is forwarded by a fifth network device, where the second configuration request message is used to configure a management and control operation of the communication apparatus, where the first network device is a core network device configured to control a network function; the fifth network device is a core network device configured to process a user plane function and/or a control plane function; the communication apparatus is a radio access network device configured to provide a communication connection function between a terminal and a core network; and the communication unit is further configured to send a second configuration response message to the first network device or the fifth network device, where the second configuration response message includes a response result of the communication apparatus for the management and control operation.

In addition, for another optional implementation of the communication apparatus in this aspect, refer to related content of the fourth aspect. Details are not described herein again.

In some embodiments, the communication unit is configured to receive a second configuration request message from a first network device, where the second configuration request message is used to configure a management and control operation of a sixth network device, where the communication unit is further configured to send the second configuration request message to the sixth network device; the communication unit is further configured to receive a second configuration response message from the sixth network device, where the second configuration response message includes a response result of the sixth network device for the management and control operation; the communication unit is further configured to send the second configuration response message to the first network device; and the first network device is a core network device configured to control a network function; the communication apparatus is a core network device configured to process a user plane function and/or a control plane function; and the sixth network device is a radio access network device configured to provide a communication connection function between a terminal and a core network.

In addition, for another optional implementation of the communication apparatus in this aspect, refer to related content of the fifth aspect. Details are not described herein again.

As an example, the communication unit may be an input/output interface, the storage unit may be a memory, and the processing unit may be a processor.

In some embodiments, the communication apparatus includes the input/output interface. The input/output interface is configured to send a first configuration request message to a second network device, where the first configuration request message is used to configure a management and control operation of the second network device, where the communication apparatus is a core network device configured to control a network function; the second network device is a core network device configured to process a user plane function and/or a control plane function; and the input/output interface is further configured to receive a first configuration response message from the second network device, where the first configuration response message includes a response result of the second network device for the management and control operation.

In addition, for another optional implementation of the communication apparatus in this aspect, refer to related content of the first aspect. Details are not described herein again.

In some embodiments, the communication apparatus includes the input/output interface. The input/output interface is configured to receive a first configuration request message from a first network device, where the first configuration request message is used to configure a management and control operation of the communication apparatus, where the first network device is a core network device configured to control a network function; the communication apparatus is a core network device configured to process a user plane function and/or a control plane function; and the input/output interface is further configured to send a first configuration response message to the first network device, where the first configuration response message includes a response result of the communication apparatus for the management and control operation.

In addition, for another optional implementation of the communication apparatus in this aspect, refer to related content of the second aspect. Details are not described herein again.

In some embodiments, the communication apparatus includes the input/output interface. The input/output interface is configured to and a communication unit is configured to send a second configuration request message to a fifth network device or a sixth network device, where the second configuration request message is used to configure a management and control operation of the sixth network device, where the communication apparatus is a core network device configured to control a network function; the fifth network device is a core network device configured to process a user plane function and/or a control plane function; the sixth network device is a radio access network device configured to provide a communication connection function between a terminal and a core network; and the input/output interface is further configured to receive a second configuration response message from the fifth network device or the sixth network device, where the second configuration response message includes a response result of the sixth network device for the management and control operation.

In addition, for another optional implementation of the communication apparatus in this aspect, refer to related content of the third aspect. Details are not described herein again.

In some embodiments, the communication apparatus includes the input/output interface. The input/output interface is configured to receive a second configuration request message from a first network device, or receive a second configuration request message from a first network device that is forwarded by a fifth network device, where the second configuration request message is used to configure a management and control operation of the communication apparatus, where the first network device is a core network device configured to control a network function; the fifth network device is a core network device configured to process a user plane function and/or a control plane function; the communication apparatus is a radio access network device configured to provide a communication connection function between a terminal and a core network; and the input/output interface is further configured to send a second configuration response message to the first network device or the fifth network device, where the second configuration response message includes a response result of the communication apparatus for the management and control operation.

In addition, for another optional implementation of the communication apparatus in this aspect, refer to related content of the fourth aspect. Details are not described herein again.

In some embodiments, the communication apparatus includes the input/output interface. The input/output interface is configured to receive a second configuration request message from a first network device, where the second configuration request message is used to configure a management and control operation of a sixth network device, where the input/output interface is further configured to send the second configuration request message to the sixth network device; the input/output interface is further configured to receive a second configuration response message from the sixth network device, where the second configuration response message includes a response result of the sixth network device for the management and control operation; the input/output interface is further configured to send the second configuration response message to the first network device; and the first network device is a core network device configured to control a network function; the communication apparatus is a core network device configured to process a user plane function and/or a control plane function; and the sixth network device is a radio access network device configured to provide a communication connection function between a terminal and a core network.

In addition, for another optional implementation of the communication apparatus in this aspect, refer to related content of the fifth aspect. Details are not described herein again.

In another possible design, the communication apparatus is a chip or a chip system. The processing unit may also be represented as a processing circuit or a logic circuit. A transceiver unit may be an input/output interface, an interface circuit, an output circuit, an input circuit, a pin, a related circuit, or the like on the chip or the chip system.

In some embodiments process, the processor may be configured to perform, for example, but not limited to, baseband-related processing; and the input/output interface may be configured to perform, for example, but not limited to, radio frequency receiving and sending. The foregoing components may be separately disposed on chips that are independent of each other, or at least some or all of the components may be disposed on a same chip. For example, the processor may be further divided into an analog baseband processor and a digital baseband processor. The analog baseband processor and the input/output interface may be integrated on a same chip, and the digital baseband processor may be disposed on an independent chip. With continuous development of an integrated circuit technology, more components may be integrated on a same chip. For example, the digital baseband processor and a plurality of application processors (for example, but not limited to, a graphics processing unit and a multimedia processor) may be integrated on a same chip. Such a chip may be referred to as a system-on-a-chip (System-on-a-Chip, SoC). Whether the components are separately disposed on different chips or integrated and disposed on one or more chips usually depends on a requirement of a product design. Implementation forms of the foregoing components are not limited in this embodiment of this application.

According to a seventh aspect, this application further provides a processor, configured to perform the foregoing methods. In a process of performing these methods, a process of sending the foregoing information and a process of receiving the foregoing information in the foregoing methods may be understood as a process of outputting the foregoing information by the processor and a process of receiving the foregoing input information by the processor. When outputting the foregoing information, the processor outputs the information to an input/output interface, so that the input/output interface transmits the information. After the foregoing information is output by the processor, other processing may further need to be performed on the information before the information arrives at the input/output interface. Similarly, when the processor receives the foregoing input information, the input/output interface receives the information, and inputs the information to the processor. Furthermore, after the input/output interface receives the information, other processing may need to be performed on the information before the information is input to the processor.

Sending, receiving, and the like related to the processor may be more generally understood as output, receiving, input, and the like of the processor, unless otherwise specified, or if the operations do not conflict with actual functions or internal logic of the operations in related descriptions.

In some embodiments process, the processor may be a processor specially configured to perform these methods, or a processor, for example, a general-purpose processor, that executes computer instructions in a memory to perform these methods. The memory may be a non-transitory (non-transitory) memory, for example, a read-only memory (read-only memory, ROM). The memory and the processor may be integrated on a same chip, or may be separately disposed on different chips. A type of the memory and a manner of disposing the memory and the processor are not limited in this embodiment of this application.

According to an eighth aspect, this application provides a computer-readable storage medium, configured to store instructions. When the instructions are run by a computer, the method according to any one of the first aspect, the second aspect, the third aspect, the fourth aspect, or the fifth aspect is implemented.

According to a ninth aspect, this application further provides a computer program product including instructions. When the computer program product is run on a computer, the method according to any one of the first aspect, the second aspect, the third aspect, the fourth aspect, or the fifth aspect is implemented.

According to a tenth aspect, this application provides a chip system. The chip system includes a processor and an interface. The interface is configured to obtain a program or instructions, and the processor is configured to invoke the program or the instructions to implement the function in the first aspect, the second aspect, the third aspect, the fourth aspect, or the fifth aspect. In some embodiments, the chip system further includes a memory. The memory is configured to store program instructions and data that are necessary for a terminal. The chip system may include a chip, or may include a chip and another discrete component.

### BRIEF DESCRIPTION OF DRAWINGS

FIG. 1 is a diagram of a system architecture according to an embodiment of this application;

FIG. 2 is a diagram of a 5G network architecture;

FIG. 3 is a schematic flowchart of a communication method 100 according to an embodiment of this application;

FIG. 4 is a schematic flowchart of a communication method 200 according to an embodiment of this application;

FIG. 5 is a schematic flowchart of a communication method 300 according to an embodiment of this application;

FIG. 6 is a diagram of configuring a flow control operation according to an embodiment of this application;

FIG. 7 is a diagram of configuring a backup operation according to an embodiment of this application;

FIG. 8 is a diagram of a structure of a communication apparatus according to an embodiment of this application;

FIG. 9 is a diagram of a structure of another communication apparatus according to an embodiment of this application; and

FIG. 10 is a diagram of a structure of a chip according to an embodiment of this application.

### DETAILED DESCRIPTION

The following clearly and completely describes the technical solutions in embodiments of this application with reference to the accompanying drawings in embodiments of this application.

To better understand a communication method disclosed in embodiments of this application, a communication system to which embodiments of this application are applicable is described.

Embodiments of this application may be applied to a 4th generation (4G) communication system, for example, a long term evolution (LTE) system, and a 5th generation (5G) communication system, for example, a new radio (NR) system. With continuous development of communication technologies, the technical solutions in embodiments of this application may be further applied to subsequently evolved communication systems, for example, a 6th generation (6G) mobile communication technology system and a 7th generation (7G) mobile communication technology system.

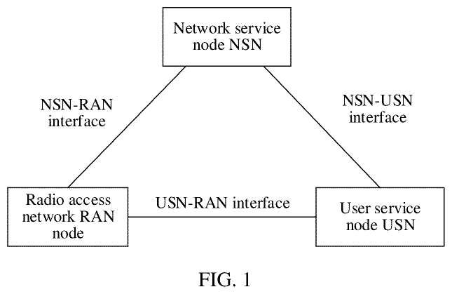

FIG. 1 is a diagram of a system architecture according to an embodiment of this application. The system architecture includes a network service node (NSN), a user service node (USN), and a radio access network (RAN) node. Quantities and forms of devices shown in FIG. 1 are used as an example, and do not constitute a limitation on this embodiment of this application. In actual application, two or more NSNs, two or more USNs, or two or more RAN nodes may be included. The system architecture shown in FIG. 1 is described by using one NSN, one USN, and one RAN node as an example.

The NSN may be configured to be responsible for a network processing related function. For example, the NSN may be configured to be responsible for network-level access, network-level authorization, network-level computing, and/or the like. The USN may be configured to be responsible for a user processing related function. For example, the USN may be configured to be responsible for user-level mobility management, user-level session management, user-level policy processing, user-plane data forwarding processing, and/or the like. The RAN node may be configured to be responsible for a radio access processing related function. In addition, an interface for communication may further exist between every two of the NSN, the USN, and the RAN node. An interface (which may also be referred to as a NAN-USN interface) between the NSN and the USN may be configured to be responsible for signaling exchange between the NSN and the USN, an interface (which may also be referred to as a NAN-RAN interface) between the NSN and the RAN node may be configured to be responsible for signaling exchange between the NSN and the RAN, and an interface (which may also be referred to as a USN-RAN interface) between the USN and the RAN node may be configured to be responsible for signaling exchange between the USN and the RAN node. In addition, “NSN” and “USN” are an example naming manner provided in this embodiment of this application. A node responsible for the network processing function and a node responsible for the user processing function may be alternatively named in another naming manner. This is not limited.

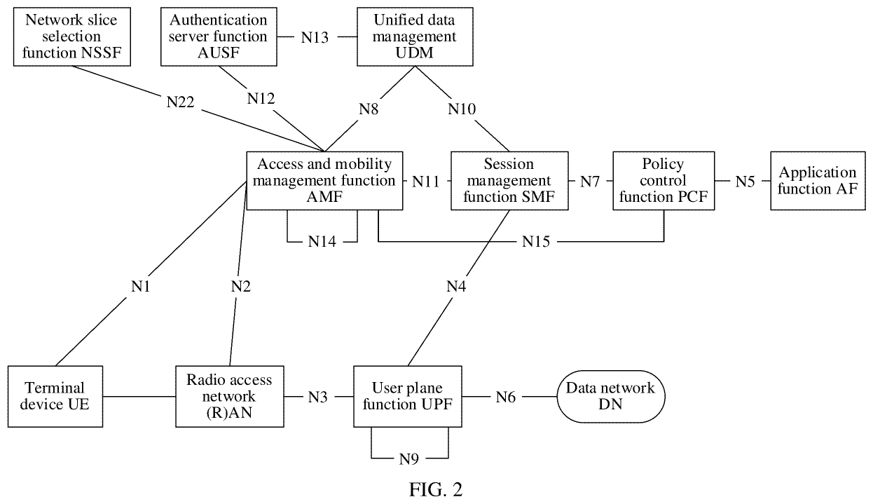

For example, in a 5G network architecture shown in FIG. 2, the NSN may be a network element having a function of performing processing by using a network as an object in a 5G core network. For example, the NSN may be a network data analytics function (NWDAF) network element, or the NSN may be a node having an access management (AM) function in an access and mobility management function (AMF) network element. The USN may be a network element having a function of performing processing by using a user as an object in the 5G core network. For example, the USN may be a session management function (SMF) network element, a policy control function (PCF) network element, or a user plane function (UPF) network element, or the USN may be a node having a mobility management (MM) function in the AMF network element.

In this embodiment of this application, the RAN node may be a base station in a 5G network or a base station in a future evolved communication system, a broadband network gateway (BNG), an aggregation switch, a non-3rd generation partnership project (3GPP) access device, or the like. Optionally, the RAN node in this embodiment of this application may include various forms of base stations, for example, a macro base station, a micro base station (also referred to as a small cell), a relay station, an access point, a device that implements a base station function in an evolved communication system after 5G, a transmitting and receiving point (TRP), a transmitting point (TP), a mobile switching center, and a device that undertakes a base station function in device-to-device (D2D) or machine-to-machine (M2M) communication. This is not specifically limited in this embodiment of this application.

When a network processing function is separated from a user processing function in a core network, the network processing function may be performed by an NSN, and the user processing function may be performed by a USN. The NSN may be controlled by an operator, and the USN may be controlled by an integrator or a user. It can be learned that the manner in which the network processing function is separated from the user processing function may provide a specific sovereign control capability for the integrator or the user, to enhance adaptability of a network to the industry. In this case, when the network processing function is separated from the user processing function, how to configure the USN and a RAN node is an urgent problem to be resolved.

A manner is manually configuring the USN and the RAN node through an operation and maintenance system or a network management system. The following performs descriptions by using an example in which configuration is manually performed through an operation support system (OSS). Because the core network and a radio access network belong to different operation domains, the USN in the core network and the RAN node in the radio access network may need to be separately configured through different OSSs. If there are a plurality of USNs, the USNs need to be manually configured one by one through an OSS corresponding to the core network. If there are a plurality of RAN nodes, the RAN nodes need to be manually configured one by one through an OSS corresponding to the radio access network. This manner is complex in configuration and is prone to an error. In addition, in the manual configuration manner, a skilled person further needs to plan configuration content in advance, and then perform configuration based on the planned configuration content. When a network status of the core network changes, in the manual RAN node configuration manner, a configuration of the RAN node cannot be updated in real time or in quasi-real time, in other words, a real-time or quasi-real-time collaborative closed-loop between the radio access network and the core network cannot be implemented.

An embodiment of this application provides a communication method 100. In the method, when a network processing function is separated from a user processing function, an NSN can directly configure a USN, thereby reducing complexity of manual configuration.

Embodiments of this application provide a communication method 200 and a communication method 300. In both manners, when a network processing function is separated from a user processing function, an NSN can configure a RAN node, so that a real-time or quasi-real-time collaborative closed-loop between a radio access network and a core network can be implemented, and complexity of manual configuration can be reduced. A difference lies in the following: In the communication method 200, the NSN directly configures the RAN node. In the communication method 300, the NSN indirectly configures the RAN node through a USN.

The following describes a communication method in embodiments of this application with reference to the accompanying drawings.

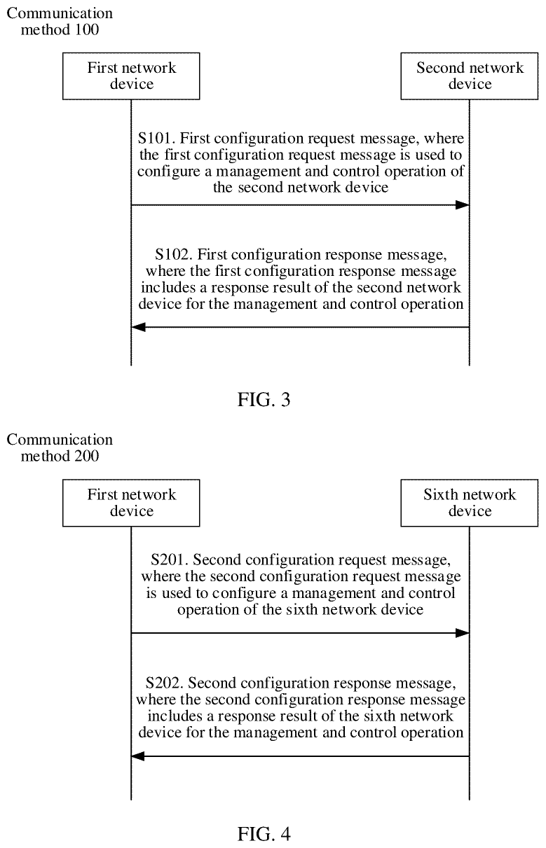

FIG. 3 is a schematic flowchart of a communication method 100 according to an embodiment of this application. The communication method 100 is described from a perspective of interaction between a first network device and a second network device. The first network device is a core network device configured to control a network function, and may be the NSN in the system architecture shown in FIG. 1. The second network device is a core network device configured to process a user plane function and/or a control plane function, and may be the USN in the system architecture shown in FIG. 1.

In addition, in this embodiment of this application, in addition to the NSN, the core network device configured to control the network function may be alternatively another core network device that can control the network function. In addition to the USN, the core network device configured to process the user plane function and/or the control plane function may be alternatively another core network device that can process the user plane function and/or the control plane function. This is not limited. This is not described below again.

The communication method 100 includes the following steps.

S101. The first network device sends a first configuration request message to the second network device, where the first configuration request message is used to configure a management and control operation of the second network device. Correspondingly, the second network device receives the first configuration request message from the first network device.

In some embodiments, the first network device may be configured to maintain a topology relationship of a core network device. Specifically, the first network device may store one or more of the following: identifiers of one or more core network devices, running statuses of the one or more core network devices, a connection relationship between the first network device and each of the one or more core network devices, a connection relationship between different core network devices in a plurality of core network devices, and the like. The one or more core network devices herein may be one or more core network devices configured to process a user plane function and/or a control plane function, and may be one or more USNs. The running status of the core network device may be represented as load, traffic, health, or the like of the core network device. In addition, the running status of the core network device may be alternatively periodically or irregularly collected and updated by the first network device. Optionally, in addition to being maintained by the first network device, the topology relationship of the core network device may be alternatively obtained by the first network device from another device such as a network repository function (NRF) or a network management system.

Before the first network device sends the first configuration request message to the second network device, the communication method may further include: the first network device determines the second network device and the first configuration request message based on a running status of the core network device in the topology relationship. For example, if traffic of a core network device in the topology relationship exceeds a preset threshold, it indicates that the core network device may need to perform flow control processing. In this case, the first network device may determine the core network device as the second network device, and the first configuration request message may be used to configure a flow control operation of the second network device.

In another optional implementation, the second network device and the first configuration request message may be manually specified by using an operation and maintenance system or a network management system.

S102. The second network device sends a first configuration response message to the first network device, where the first configuration response message includes a response result of the second network device for the management and control operation. Correspondingly, the first network device receives the first configuration response message from the second network device.

In this embodiment of this application, the management and control operation may be an operation related to an access management and control function in a next generation application protocol (NGAP). For example, the management and control operation may be an operation related to configuration (Configuration), reset (Reset) indication, error indication (Error indication), fault status indication (Status indication), overload (Overload) start/stop, flow control start/stop, or the like of key data. The configuration of the key data may be configuring a supported network slice or a supported capability, and the fault status indication may be requesting to release a connection context. In addition, the flow control operation and the backup operation that are described below are two example management and control operations provided in embodiments of this application. The management and control operation may be alternatively another operation described above. Details are not described.

In some embodiments, the communication method may further include: the first network device sends an operation type and/or a parameter related to the management and control operation to the second network device. Optionally, the operation type and/or the parameter related to the management and control operation may be carried in the first configuration request message.

In some embodiments, the first configuration request message is used to configure a flow control operation of the second network device; and the first configuration response message includes a response result of the second network device for the flow control operation. In other words, the first network device may control the second network device to perform flow control processing. In addition, the response result of the second network device for the flow control operation may include a result of determining, by the second network device, whether to perform flow control processing. Optionally, in this case, the operation type sent by the first network device to the second network device may be flow control start, and the parameter related to the management and control operation includes a flow control parameter. The flow control parameter may include a load decrease index of the second network device, an identifier of a network slice that needs to perform flow control processing in network slices supported by the second network device, and/or the like.

In some embodiments, the first configuration request message is used to configure a backup operation of the second network device for a user context of a third network device; and the first configuration response message includes a response result of the second network device for the backup operation. The third network device is a core network device configured to process a user plane function and/or a control plane function, and may be another USN different from the second network device. In other words, the first network device may control the second network device to back up the user context of the third network device. In this backup operation, the second network device is used as a backup destination, and the third network device is used as a backup source. In addition, the response result of the second network device for the backup operation may include a result of determining, by the second network device, whether to back up the user context of the third network device. Optionally, in this case, the operation type sent by the first network device to the second network device may be backup, and the parameter related to the management and control operation may include an identifier of the backup destination and an identifier of the backup source.

Optionally, if the response result of the second network device for the backup operation is an acknowledgment, in other words, the response result includes that the second network device determines to back up the user context of the third network device, the communication method may further include: the first network device sends a third configuration request message to the third network device, where the third configuration request message is used to configure the backup operation of the user context of the third network device. Correspondingly, the third network device receives the third configuration request message, and sends a third configuration response message to the first network device, where the third configuration response message includes a response result of the third network device for the backup operation. The response result of the third network device for the backup operation may include a result of determining, by the third network device, whether to allow the user context of the third network device to be backed up. Optionally, in this case, the first network device may further send an identifier of the second network device used as the backup destination to the third network device. In addition to the result of determining, by the third network device, whether to allow the user context of the third network device to be backed up, the response result of the third network device for the backup operation may further include a result of determining whether to allow the second network device to be used as the backup destination. Optionally, the identifier of the second network device used as the backup destination may be carried in the third configuration request message. Optionally, the identifier of the second network device may be an address of the second network device.

Optionally, if the response result of the third network device for the backup operation is an acknowledgment, in other words, the response result includes that the third network device allows the user context of the third network device to be backed up, the method may further include: the first network device notifies a tenth network device of a backup relationship between the second network device and the third network device. The tenth network device is a radio access network device that is connected to the second network device and the third network device and that is configured to provide a communication connection function between a terminal and a core network, and may be a RAN node connected to the second network device and the third network device.

A specific implementation in which the first network device notifies the tenth network device of the backup relationship between the second network device and the third network device includes the following implementation 1.1 and implementation 1.2.
Implementation 1.1: The first network device sends a fourth configuration request message to the tenth network device, where the fourth configuration request message is used to configure a storage operation of the tenth network device for the backup relationship between the second network device and the third network device. Correspondingly, the tenth network device receives the fourth configuration request message from the first network device. The tenth network device sends a fourth configuration response message to the first network device, where the fourth configuration response message includes a response result of the tenth network device for the storage operation. Correspondingly, the first network device receives the fourth configuration response message from the tenth network device.
Implementation 1.2: The first network device sends a fourth configuration request message to the second network device, where the fourth configuration request message is used to configure a storage operation of the tenth network device for the backup relationship between the second network device and the third network device. The second network device forwards the fourth configuration request message to the tenth network device. The tenth network device sends a fourth configuration response message to the second network device, where the fourth configuration response message includes a response result of the tenth network device for the storage operation. The second network device forwards the fourth configuration response message to the first network device. In addition, in addition to the manner in which the fourth configuration request message and the fourth configuration response message are forwarded through the second network device, the fourth configuration request message and the fourth configuration response message may be alternatively forwarded through the third network device. The two manners are similar, and details are not described.

Based on the implementation 1.1 and the implementation 1.2, it can be learned that the first network device may notify, by using the fourth configuration request message, the tenth network device that the second network device backs up the user context of the third network device. In this case, if the response result of the tenth network device for the storage operation is an acknowledgment, the tenth network device may store the backup relationship, where the backup relationship indicates that the second network device backs up the user context of the third network device. In this case, when a connection error occurs between the tenth network device and the third network device, a fault occurs in the third network device, or another problem occurs, the tenth network device may be connected to the second network device, and the tenth network device may communicate with the second network device based on the user context backed up by the second network device, thereby avoiding signaling overheads and power consumption that are generated when a new user context is generated between the tenth network device and the second network device.

In some embodiments, the first configuration response message is determined by the second network device based on the first configuration request message and a first message from a fourth network device or a network management system. The first message is used to configure a management and control operation of the second network device, and a type of the management and control operation configured by using the first message is the same as a type of the management and control operation configured by using the first configuration request message. The fourth network device is a radio access network device configured to provide a communication connection function between a terminal and a core network, and may be a RAN node. The fourth network device may be the same as or different from the tenth network device. In addition, the same types of the management and control operations mentioned in this embodiment of this application are not limited to completely consistent types, and may be related types. This is not described below again. For example, two management and control operations, namely, flow control start and flow control stop, are both operations related to flow control, and it may also be considered that types of the two management and control operations are the same.

A manner of determining the response result in the first configuration response message may include some embodiments 2.1 to some embodiments 2.4.
Implementation 2.1: The response result includes an acknowledgment of the second network device for the management and control operation configured by using the first configuration request message, and an acknowledgment of the second network device for the management and control operation configured by using the first message.
Implementation 2.2: The response result is an acknowledgment of the second network device for a same point between the management and control operation configured by using the first configuration request message and the management and control operation configured by using the first message.

For example, both the management and control operation configured by using the first message and the management and control operation configured by using the first configuration request message are operations related to flow control. Specifically, the first configuration request message is used to configure flow control operations of the second network device for a network slice 1 and a network slice 2, and the first message is used to configure flow control operations of the second network device for the network slice 2 and a network slice 3. In this case, the response result that is in the first configuration response message and that is determined based on the implementation 2.1 includes that the second network device performs flow control processing on the network slice 1, the network slice 2, and the network slice 3. The response result that is in the first configuration response message and that is determined based on the implementation 2.2 includes that the second network device performs flow control processing on the network slice 2.
Implementation 2.3: A priority of the first configuration request message is higher than a priority of the first message, and the response result is an acknowledgment of the second network device for the management and control operation configured by using the first configuration request message. In this implementation, a configuration of the NSN for the USN can have a higher priority, thereby implementing a high-priority operation right of network-level processing.
Implementation 2.4: A priority of the first message is higher than a priority of the first configuration request message, and the response result is an acknowledgment of the second network device for the management and control operation configured by using the first message.

For example, the first configuration request message is used to configure flow control operations of the second network device for a network slice 1 and a network slice 2, and the first message is used to configure a flow control operation of the second network device for a network slice 3. In this case, the response result that is in the first configuration response message and that is determined based on the implementation 2.3 includes that the second network device performs flow control processing on the network slice 1 and the network slice 2. The response result that is in the first configuration response message and that is determined based on the implementation 2.4 includes that the second network device performs flow control processing on the network slice 3.

For another example, the first configuration request message is used to configure a flow control operation (or a flow control start operation) of the second network device, in other words, the first network device configures the second network device to perform flow control processing. The first message is used to configure a flow control stop operation of the second network device, in other words, the fourth network device or the network system configures the second network device not to perform flow control processing. In this case, the response result that is in the first configuration response message and that is determined based on the implementation 2.3 is the acknowledgment of the second network device for the management and control operation configured by using the first configuration request message, to be specific, the response result includes that the second network device performs flow control processing. The response result that is in the first configuration response message and that is determined based on the implementation 2.4 is the acknowledgment of the second network device for the management and control operation configured by using the first message, to be specific, the response result includes that the second network device does not perform flow control processing.

In conclusion, in the communication method 100, the first network device may send the first configuration request message to the second network device, where the first configuration request message is used to configure the management and control operation of the second network device; and the second network device receives the first configuration request message, and sends the first configuration response message to the first network device, where the first configuration response message includes the response result of the second network device for the management and control operation. The first network device is a core network device configured to control a network function, and the second network device is a core network device configured to process a user plane function and/or a control plane function. In the communication method 100, the core network device configured to control the network function can directly configure the core network device configured to process the user plane function and/or the control plane function.

The core network device configured to control the network function may be a node responsible for a network processing function, and the core network device configured to process the user plane function and/or the control plane function may be a node responsible for a user processing function. The method can support an architecture in which the network processing function is separated from the user processing function. Therefore, when the network processing function is separated from the user processing function, the node responsible for the network processing function can interact with the node responsible for the user processing function, so that the node responsible for the network processing function directly configures/controls the node responsible for the user processing function, thereby reducing complexity of manual configuration and avoiding an error.

FIG. 4 is a schematic flowchart of a communication method 200 according to an embodiment of this application. The communication method 200 is described from a perspective of interaction between a first network device and a sixth network device. The sixth network device is a radio access network device configured to provide a communication connection function between a terminal and a core network, and may be the RAN node in the system architecture shown in FIG. 1. In addition, the sixth network device may be the same as or different from the fourth network device or the tenth network device in the communication method 100. The communication method 200 includes the following steps.

S201. The first network device sends a second configuration request message to the sixth network device, where the second configuration request message is used to configure a management and control operation of the sixth network device. Correspondingly, the sixth network device receives the second configuration request message from the first network device.

In some embodiments, the first network device may be configured to maintain a topology relationship of a radio access network device. Specifically, the first network device may store one or more of the following: identifiers of one or more radio access network devices, running statuses of the one or more radio access network devices, a connection relationship between the first network device and each of the one or more radio access network devices, a connection relationship between different radio access network devices in a plurality of radio access network devices, and the like. The one or more radio access network devices herein are radio access network devices configured to provide a communication connection function between a terminal and a core network, and may be one or more RAN nodes. The running status of the radio access network device may be represented as load, traffic, health, or the like of the radio access network device. In addition, the running status of the radio access network device may be alternatively periodically or irregularly collected and updated by the first network device. Optionally, in addition to being maintained by the first network device, the topology relationship of the radio access network device may be alternatively obtained by the first network device from another device such as an NRF or a network management system.

Before the first network device sends the second configuration request message to the sixth network device, the communication method may further include: the first network device determines the sixth network device and the second configuration request message based on a running status of the radio access network device in the topology relationship. For example, if traffic of a radio access network device in the topology relationship exceeds a preset threshold, it indicates that the radio access network device may need to perform flow control processing. In this case, the first network device may determine the radio access network device as the sixth network device, and the second configuration request message is used to configure a flow control operation of the sixth network device.

In another optional implementation, the sixth network device and the second configuration request message may be manually specified by using an operation and maintenance system or a network management system.

S202. The sixth network device sends a second configuration response message to the first network device, where the second configuration response message includes a response result of the sixth network device for the management and control operation. Correspondingly, the first network device receives the first configuration response message from the sixth network device. For specific descriptions of the management and control operation, refer to the related descriptions in the communication method 100. Details are not described again.

In some embodiments, the communication method may further include: the first network device sends an operation type and/or a parameter related to the management and control operation to the sixth network device. Optionally, the operation type and/or the parameter related to the management and control operation may be carried in the second configuration request message.

In some embodiments, the second configuration request message is used to configure a flow control operation of the sixth network device; and the second configuration response message includes a response result of the sixth network device for the flow control operation. The flow control operation in this implementation is similar to the flow control operation of the second network device in the communication method 100, and details are not described.

In some embodiments, the second configuration request message is used to configure a storage operation of the sixth network device for a backup relationship between a seventh network device and an eighth network device, and the second configuration response message includes a response result of the sixth network device for the storage operation. The seventh network device and the eighth network device are core network devices that are connected to the sixth network device and that are configured to process a user plane function and/or a control plane function. The seventh network device and the eighth network device may be different USNs. The backup operation in this implementation is similar to the backup operation of the tenth network device for the backup relationship between the second network device and the third network device in the communication method 100, and details are not described.

In some embodiments, the second configuration response message is determined by the sixth network device based on the second configuration request message and a second message from a ninth network device or a network management system; the second message is used to configure a management and control operation of the sixth network device, and a type of the management and control operation configured by using the second message is the same as a type of the management and control operation configured by using the second configuration request message; and the ninth network device is a core network device configured to process a user plane function and/or a control plane function, and may be a USN. The ninth network device may be the same as or different from the seventh network device or the eighth network device. In addition, a specific implementation of determining the response result in the second configuration response message is similar to the implementation of determining the response result in the first configuration response message in the communication method 100, and details are not described. In conclusion, in the communication method 200, the first network device sends the second configuration request message to the sixth network device, where the second configuration request message is used to configure the management and control operation of the sixth network device; and the sixth network device receives the second configuration request message, and sends the second configuration response message to the first network device, where the second configuration response message includes the response result of the sixth network device for the management and control operation. The first network device is a core network device configured to control a network function, and the sixth network device is a radio access network device configured to provide a communication connection function between a terminal and a core network. In the communication method 200, the core network device configured to control the network function can directly configure the radio access network device.

The core network device configured to control the network function may be a node responsible for a network processing function, and the core network device configured to process the user plane function and/or the control plane function may be a node responsible for a user processing function. The method can support an architecture in which the network processing function is separated from the user processing function. Therefore, when the network processing function is separated from the user processing function, the node responsible for the network processing function can interact with the radio access network device, so that the node responsible for the network processing function directly configures/controls the radio access network device, thereby implementing a real-time or quasi-real-time collaborative closed-loop between a radio access network and the core network, reducing complexity of manual configuration, and avoiding an error.

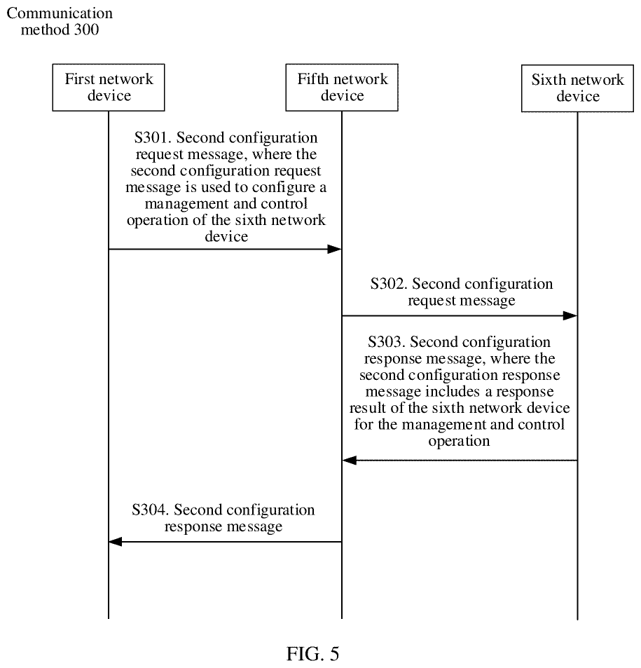

FIG. 5 is a schematic flowchart of a communication method 300 according to an embodiment of this application. The communication method 300 is described from a perspective of interaction between a first network device, a fifth network device, and a sixth network device. The fifth network device is a core network device configured to process a user plane function and/or a control plane function, and may be the USN in the system architecture shown in FIG. 1.

In both the communication method 300 and the communication method 200, the first network device can configure the sixth network device. A difference lies in the following: In the communication method 200, the first network device can directly interact with the sixth network device, in other words, the first network device can directly configure the sixth network device. In the communication method 300, the NSN can interact with the USN, and the USN can interact with the RAN node, in other words, the first network device indirectly configures the sixth network device. The communication method 300 includes the following steps.

S301. The first network device sends a second configuration request message to the fifth network device, where the second configuration request message is used to configure a management and control operation of the sixth network device. Correspondingly, the fifth network device receives the second configuration request message from the first network device.

S302. The fifth network device sends the second configuration request message to the sixth network device. Correspondingly, the sixth network device receives the second configuration request message from the first network device that is forwarded by the fifth network device.

In some embodiments, the first network device may be configured to maintain a topology relationship of a core network device and/or a topology relationship of a radio access network device. Before the first network device sends the second configuration request message to the fifth network device, the communication method may further include: the first network device determines the fifth network device and/or the sixth network device and the second configuration request message based on a running status of the core network device in the topology relationship and/or a running status of the radio access network device in the topology relationship. Optionally, in addition to being maintained by the first network device, the topology relationship of the core network device and/or the topology relationship of the radio access network device may be alternatively obtained by the first network device from another device such as an NRF or a network management system.

The following uses an example in which the first network device maintains the topology relationship of the core network device and/or the topology relationship of the radio access network device. A specific implementation in which the first network device determines the fifth network device and/or the sixth network device and the second configuration request message may include some embodiments 3.1 and some embodiments 3.2.
Implementation 3.1: The first network device may be configured to maintain the topology relationship of the core network device. In this case, the first network device may determine the fifth network device and the second configuration request message based on the running status of the core network device in the topology relationship, and the fifth network device determines the sixth network device based on a running status of a radio access network device connected to the fifth network device. For example, if traffic of a core network device #1 in the topology relationship maintained by the first network device exceeds a first value, the first network device may determine the core network device #1 as the fifth network device, and the second configuration request message may be used to configure a flow control operation of a radio access network device connected to the core network device #1. If traffic of a radio access network device #1 connected to the fifth network device exceeds a second value, the fifth network device may determine the radio access network device #1 as the sixth network device, and send the second configuration request message to the radio access network device #1, so that the first network device configures the radio access network device #1 to perform flow control.
Implementation 3.2: The first network device may be configured to maintain the topology relationship of the core network device and the topology relationship of the radio access network device. In other words, the first network device may learn of the running status of the core network device, the running status of the radio access network device, and a connection relationship between the core network device and the radio access network device. In this case, a manner in which the first network device determines the fifth network device and the sixth network device may include some embodiments 3.1.1 and some embodiments 3.1.2.
Implementation 3.2.1: The first network device may determine the sixth network device and the second configuration request message based on the running status of the radio access network device in the topology relationship, and the first network device determines, as the fifth network device, a core network device connected to the sixth network device. For example, if traffic of a radio access network device #1 in the topology relationship exceeds a second value, the first network device may determine the radio access network device #1 as the sixth network device, and the determined second configuration request message is used to configure a flow control operation of the radio access network device #1. Further, the first network device may determine, as the fifth network device, a core network device #1 connected to the radio access network device #1. In this case, the first network device may send the second configuration request message to the core network device #1, and then the core network device #1 sends the second configuration request message to the radio access network device #1, so that the first network device configures the radio access network device #1 to perform flow control.
Implementation 3.2.2: The first network device may determine the fifth network device based on the running status of the core network device in the topology relationship, and determine the sixth network device and the second configuration request message based on the running status of the radio access network device. For example, if traffic of a core network device #1 in the topology relationship maintained by the first network device exceeds a first value, and traffic of a radio access network device #1 connected to the core network device #1 exceeds a second value, the first network device may determine the core network device #1 as the fifth network device, and determine the radio access network device #1 as the sixth network device, and the second configuration request message is used to configure a flow control operation of the radio access network device #1.

In addition, in the foregoing implementations, the first value and the second value may be predefined, or may be determined based on a network traffic status. This is not limited.

S303. The sixth network device sends a second configuration response message to the fifth network device, where the second configuration response message includes a response result of the sixth network device for the management and control operation. Correspondingly, the fifth network device receives the second configuration response message from the sixth network device.

S304. The fifth network device sends the second configuration response message to the first network device. Correspondingly, the first network device receives the second configuration response message from the fifth network device.

For specific descriptions of the management and control operation, the second configuration request message, and the second configuration response message, refer to the related descriptions in the communication method 200. Details are not described again.

In conclusion, in the communication method 300, the first network device sends the second configuration request message to the fifth network device, where the second configuration request message is used to configure the management and control operation of the sixth network device; the fifth network device forwards the second configuration request message to the sixth network device; the sixth network device receives the second configuration request message, and sends the second configuration response message to the fifth network device, where the second configuration response message includes the response result of the sixth network device for the management and control operation; and the fifth network device forwards the second configuration response message to the first network device. The first network device is a core network device configured to control a network function, the fifth network device is a core network device configured to process a user plane function and/or a control plane function, and the sixth network device is a radio access network device configured to provide a communication connection function between a terminal and a core network. In the communication method 300, the core network device configured to control the network function can indirectly configure the radio access network device through the core network device configured to process the user plane function and/or the control plane function.

The core network device configured to control the network function may be a node responsible for a network processing function, and the core network device configured to process the user plane function and/or the control plane function may be a node responsible for a user processing function. The method can support an architecture in which the network processing function is separated from the user processing function. Therefore, when the network processing function is separated from the user processing function, the node responsible for the network processing function can interact with the node responsible for the user processing function, and the node responsible for the user processing function can interact with the radio access network device, so that the node responsible for the network processing function can indirectly configure/control the radio access network device through the node responsible for the user processing function, thereby implementing a real-time or quasi-real-time collaborative closed-loop between a radio access network and the core network, reducing complexity of manual configuration, and avoiding an error.

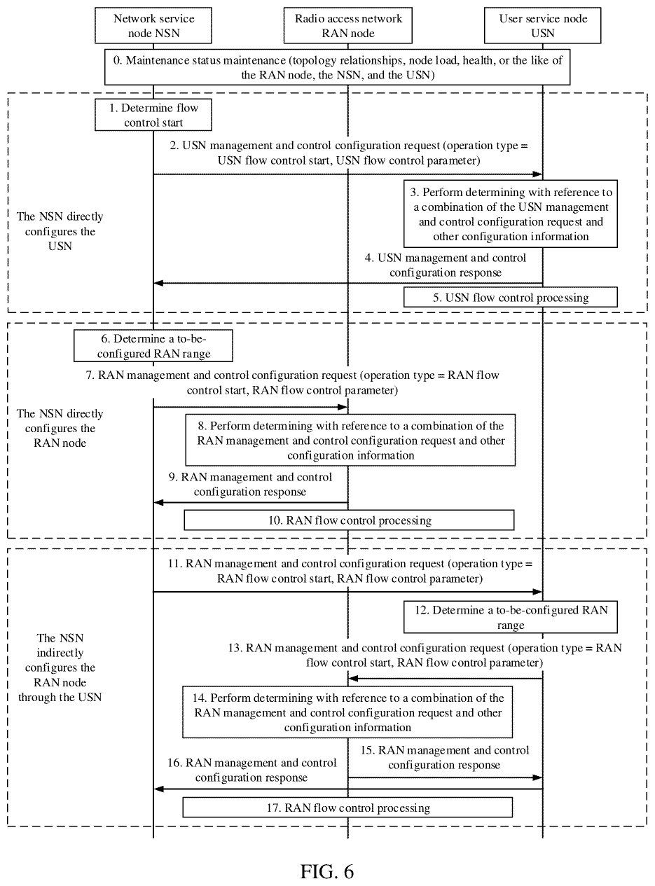

With reference to FIG. 6, the following provides descriptions by using an example in which a first network device configures a second network device and a sixth network device to perform flow control processing, the first network device is an NSN having an access management (AM) function, the second network device is a USN having a mobility management (MM) function, and the sixth network device is a RAN node connected to the second network device. In this scenario, the NSN may maintain topology relationships of a RAN node, an NSN, and a USN, and determine, based on running statuses of nodes in the topology relationships, to configure flow control start of the USN and the RAN node.

In FIG. 6, steps 1 to 5 show a process in which the NSN configures the USN to perform flow control processing. Specifically, the NSN may further determine a to-be-configured USN in a process of determining flow control start, and then initiate a USN management and control configuration request to the to-be-configured USN. The USN may determine, with reference to a combination of the USN management and control configuration request and other configuration information (for example, a first message from a RAN node or a network management system), whether to perform flow control processing, and initiate a USN management and control configuration response to the NSN. If the USN determines to perform flow control processing, the USN may perform flow control processing. A sequence in which the USN initiates the USN management and control configuration response to the NSN and performs flow control processing is not limited. In addition, a process in which the NSN initiates the USN management and control configuration request to the USN may include: the NSN sends a first configuration request message to the USN, where the first configuration request message may carry an operation type and a USN flow control parameter, and the operation type is USN flow control start. A process in which the USN initiates the USN management and control configuration response to the NSN may include: the USN sends a first configuration response message to the NSN, where the first configuration response message includes a result of determining, by the USN, whether to perform flow control processing.

Steps 6 to 10 show a process in which the NSN directly configures the RAN node to perform flow control processing. Specifically, the NSN determines a to-be-configured RAN node, and then initiates a RAN management and control configuration request to the to-be-configured RAN node. The RAN node may determine, with reference to a combination of the RAN management and control configuration request and other configuration information (for example, a second message from a USN or a network management system), whether to perform flow control processing, and initiate a RAN management and control configuration response to the NSN. If the RAN node determines to perform flow control processing, the RAN node may perform flow control processing. A sequence in which the RAN node initiates the RAN management and control configuration response to the NSN and performs flow control processing is not limited. In addition, a process in which the NSN initiates the RAN management and control configuration request to the RAN node may include: the NSN sends a second configuration request message to the RAN node, where the second configuration request message may carry an operation type and a RAN flow control parameter, and the operation type is RAN flow control start. A process in which the RAN node initiates the RAN management and control configuration response to the NSN may include: the RAN node sends a second configuration response message to the NSN, where the second configuration response message includes a result of determining, by the RAN node, whether to perform flow control processing.

Steps 11 to 17 show a process in which the NSN indirectly configures, through the USN, the RAN node to perform flow control processing. A difference between this manner and the manner in which the NSN directly configures the RAN node to perform flow control processing lies in the following: In this manner, a RAN management and control configuration request and a RAN management and control configuration response are forwarded by the USN, and a to-be-configured RAN node may be determined by the USN.

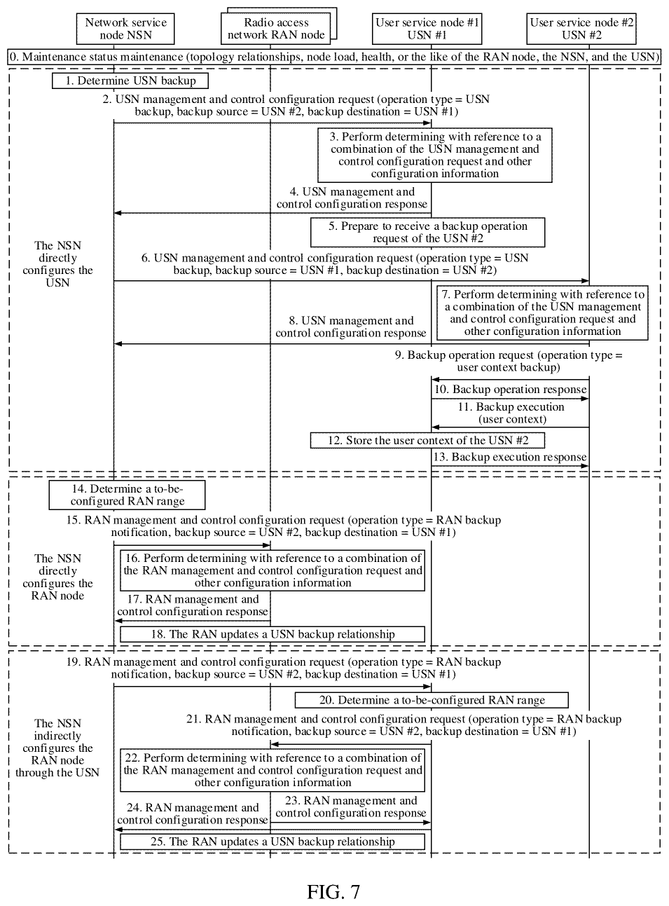

With reference to FIG. 7, the following provides descriptions by using an example in which a first network device configures a second network device to back up a user context of a third network device, the first network device configures a sixth network device to store this backup relationship, the first network device is an NSN having an AM function, the second network device is a USN #1 having an MM function, the third network device is a USN #2 having the MM function, and the sixth network device is a RAN node connected to the USN #1 and the USN #2. In this scenario, the NSN may maintain topology relationships of a RAN node, an NSN, and a USN, and determine, based on running statuses of nodes in the topology relationships, to configure backup between the USN #1 and the USN #2. In addition, after the USN #1 backs up a user context of the USN #2, the NSN further notifies the RAN node connected to the USN #1 and the USN #2 of the backup relationship between the USN #1 and the USN #2.

In FIG. 7, steps 1 to 13 show a process in which the USN #1 backs up the user context of the USN #2. Specifically, in a process of determining USN backup, the NSN may further determine that a backup destination is the USN #1 and a backup source is the USN #2. The NSN may initiate a USN management and control configuration request to the USN #1. The USN #1 may determine, with reference to a combination of the USN management and control configuration request and other configuration information (for example, a first message from a RAN node or a network management system), whether to back up the user context of the USN #2, and initiate a USN management and control configuration response to the NSN. If the USN #1 determines to back up the user context of the USN #2, the USN #1 may prepare to receive a backup operation request from the USN #2, and the NSN may initiate a USN management and control configuration request to the USN #2. The USN #2 may determine, with reference to a combination of the USN management and control configuration request and other configuration information, whether to allow the user context of the USN #2 to be backed up by the USN #1, and initiate a USN management and control configuration response to the NSN. If the USN #2 allows the user context of the USN #2 to be backed up by the USN #1, the USN #2 may initiate, to the USN #1, a backup operation request carrying an operation type that is user context backup. After completing the preparation, the USN #1 initiates a backup operation response to the USN #2. Then, the USN #2 may send, to the USN #1, a backup execution message that carries the user context. The USN #1 stores the received user context, and sends a backup execution response to the USN #2. Step 11 to step 13 may be repeated for a plurality of times until the USN #2 backs up all of the user context of the USN #1. In addition, after determining that the backup is completed, the USN #2 may further notify the NSN of a backup completion message.

The initiating, by the NSN, a USN management and control configuration request may include: the NSN sends a first configuration request message, where the first configuration request message carries an operation type, an identifier of the USN #1, and an identifier of the USN #2, and the operation type is USN backup. The initiating, by the USN #1, a USN management and control configuration response to the NSN may include: the USN #1 sends a first configuration request response to the NSN, where the first configuration request response includes a result of determining, by the USN #1, whether to back up the user context of the USN #2. The initiating, by the USN #2, a USN management and control configuration response to the NSN may include: the USN #2 sends a first configuration request response to the NSN, where the first configuration request response includes a result of determining, by the USN #2, whether to allow the user context of the USN #2 to be backed up by the USN #1. Optionally, the identifier of the USN #1 and the identifier of the USN #2 may be respectively addresses of the USN #1 and the USN #2.

Steps 14 to 18 show a process in which the NSN directly configures the RAN node to store the backup relationship between the USN #1 and the USN #2. Specifically, the NSN determines one or more RAN nodes connected to the USN #1 and the USN #2, and then initiates a RAN management and control configuration request to each determined RAN node. Each RAN node may determine a to-be-stored USN backup relationship with reference to the RAN management and control configuration request and other configuration information (for example, a second message from a USN or a network management system), and initiate a RAN management and control configuration response to the NSN. Each RAN node stores the to-be-stored USN backup relationship. A sequence in which the RAN node initiates the RAN management and control configuration response to the NSN and stores the to-be-stored USN backup relationship is not limited. In addition, a process in which the NSN initiates the RAN management and control configuration request to the RAN node may include: the NSN sends a second configuration request message to the RAN node, where the second configuration request message may carry an operation type, an identifier of the backup source (the USN #2), and an identifier of the backup destination (the USN #1), and the operation type is RAN backup notification. The initiating, by the RAN node, a RAN management and control configuration response to the NSN may include: the RAN node sends a second configuration response message to the NSN, where the second configuration response message includes the to-be-stored USN backup relationship determined by the RAN node.

Steps 19 to 25 show a process in which the NSN indirectly configures, through the USN #1, the RAN node to store the backup relationship between the USN #1 and the USN #2. A difference between this manner and the manner shown in steps 14 to 18 lies in the following: In the manner shown in steps 19 to 25, a RAN management and control configuration request and a RAN management and control configuration response are forwarded by the USN #1, and a to-be-configured RAN node may be determined by the USN #1. In addition, the NSN may alternatively indirectly configure, through the USN #2, the RAN node to store the backup relationship between the USN #1 and the USN #2. Details are not described.

To implement the foregoing functions in the method provided in embodiments of this application, the network device or the terminal device may include a hardware structure and/or a software module, and implement the foregoing functions in a form of the hardware structure, the software module, or a combination of the hardware structure and the software module. Whether a function in the foregoing functions is performed by using the hardware structure, the software module, or the combination of the hardware structure and the software module depends on particular applications and design constraints of the technical solutions.

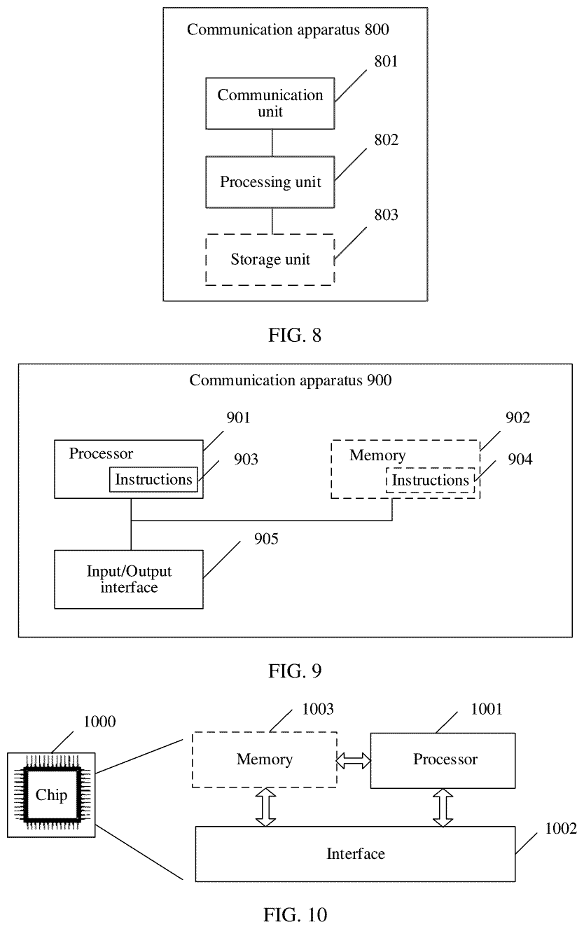

As shown in FIG. 8, an embodiment of this application provides a communication apparatus 800. The communication apparatus 800 may be a first network device, a second network device, a fifth network device, or a sixth network device, or the communication apparatus 800 may be a component (for example, an integrated circuit or a chip) that supports the first network device, the second network device, the fifth network device, or the sixth network device in implementing the foregoing method. Alternatively, the communication apparatus 800 may be another communication unit, configured to implement the methods in the method embodiments of this application. The communication apparatus 800 may include a communication unit 801 and a processing unit 802. The processing unit 802 is configured to control the communication unit 801 to perform data/signaling receiving and sending. Optionally, the communication apparatus 800 may further include a storage unit 803.

In some embodiments, the communication apparatus 800 is a core network device configured to control a network function. The communication unit 801 is configured to send a first configuration request message to a second network device, where the first configuration request message is used to configure a management and control operation of the second network device. The second network device is a core network device configured to process a user plane function and/or a control plane function.

The communication unit 801 is further configured to receive a first configuration response message from the second network device, where the first configuration response message includes a response result of the second network device for the management and control operation.

In some embodiments, the communication apparatus 800 is configured to maintain a topology relationship of a core network device. The processing unit 802 is configured to determine the second network device and the first configuration request message based on a running status of the core network device in the topology relationship before the communication unit 801 sends the first configuration request message to the second network device.

In some embodiments, the first configuration request message is used to configure a flow control operation of the second network device; and the first configuration response message includes a response result of the second network device for the flow control operation.

In some embodiments, the first configuration request message is used to configure a backup operation of the second network device for a user context of a third network device; the first configuration response message includes a response result of the second network device for the backup operation; and the third network device is a core network device configured to process a user plane function and/or a control plane function.

In another possible design, the communication apparatus 800 is a core network device configured to process a user plane function and/or a control plane function. The communication unit 801 is configured to receive a first configuration request message from a first network device, where the first configuration request message is used to configure a management and control operation of the communication apparatus 800. The first network device is a core network device configured to control a network function.

The communication unit 801 is further configured to send a first configuration response message to the first network device, where the first configuration response message includes a response result of the communication apparatus 800 for the management and control operation.

In some embodiments, the first configuration response message is determined by the processing unit 802 based on the first configuration request message and a first message from a fourth network device or a network management system; the first message is used to configure a management and control operation of the communication apparatus 800, and a type of the management and control operation configured by using the first message is the same as a type of the management and control operation configured by using the first configuration request message; and the fourth network device is a radio access network device configured to provide a communication connection function between a terminal and a core network.

In some embodiments, a priority of the first configuration request message is higher than a priority of the first message, and the response result is an acknowledgment of the communication apparatus 800 for the management and control operation configured by using the first configuration request message.

In some embodiments, the first configuration request message is used to configure a flow control operation of the communication apparatus 800; and the first configuration response message includes a response result of the communication apparatus 800 for the flow control operation.

In some embodiments, the first configuration request message is used to configure a backup operation of the communication apparatus 800 for a user context of a third network device; the first configuration response message includes a response result of the communication apparatus 800 for the backup operation; and the third network device is a core network device configured to process a user plane function and/or a control plane function.

In another possible design, the communication apparatus 800 is a core network device configured to control a network function. The communication unit 801 is configured to send a second configuration request message to a fifth network device or a sixth network device, where the second configuration request message is used to configure a management and control operation of the sixth network device. The fifth network device is a core network device configured to process a user plane function and/or a control plane function; and the sixth network device is a radio access network device configured to provide a communication connection function between a terminal and a core network.

The communication unit 801 is further configured to receive a second configuration response message from the fifth network device or the sixth network device, where the second configuration response message includes a response result of the sixth network device for the management and control operation.

In some embodiments, the communication apparatus 800 is configured to maintain a topology relationship of a core network device and/or a topology relationship of a radio access network device. The processing unit 802 is configured to determine the fifth network device and/or the sixth network device and the second configuration request message based on a running status of the core network device in the topology relationship and/or a running status of the radio access network device in the topology relationship before the communication unit 801 sends the second configuration request message to the fifth network device or the sixth network device.

In some embodiments, the second configuration request message is used to configure a flow control operation of the sixth network device; and the second configuration response message includes a response result of the sixth network device for the flow control operation.

In some embodiments, the second configuration request message is used to configure a storage operation of the sixth network device for a backup relationship between a seventh network device and an eighth network device; the second configuration response message includes a response result of the sixth network device for the storage operation; and the seventh network device and the eighth network device are core network devices that are connected to the sixth network device and that are configured to process a user plane function and/or a control plane function.

In another possible design, the communication apparatus 800 is a radio access network device configured to provide a communication connection function between a terminal and a core network. The communication unit 801 is configured to receive a second configuration request message from a first network device, or receive a second configuration request message from a first network device that is forwarded by a fifth network device, where the second configuration request message is used to configure a management and control operation of the communication apparatus 800. The first network device is a core network device configured to control a network function; and the fifth network device is a core network device configured to process a user plane function and/or a control plane function.

The communication unit 801 is further configured to send a second configuration response message to the first network device or the fifth network device, where the second configuration response message includes a response result of the communication apparatus 800 for the management and control operation.

In some embodiments, the second configuration response message is determined by the processing unit 802 based on the second configuration request message and a second message from a ninth network device or a network management system; the second message is used to configure a management and control operation of the communication apparatus 800, and a type of the management and control operation configured by using the second message is the same as a type of the management and control operation configured by using the second configuration request message; and the ninth network device is a core network device configured to process a user plane function and/or a control plane function.

In some embodiments, a priority of the second configuration request message is higher than a priority of the second message, and the response result is an acknowledgment of the communication apparatus 800 for the management and control operation configured by using the second configuration request message.

In some embodiments, the second configuration request message is used to configure a flow control operation of the communication apparatus 800, and the second configuration response message includes a response result of the communication apparatus 800 for the flow control operation.

In some embodiments, the second configuration request message is used to configure a storage operation of the communication apparatus 800 for a backup relationship between a seventh network device and an eighth network device; the second configuration response message includes a response result of the communication apparatus 800 for the storage operation; and the seventh network device and the eighth network device are core network devices that are connected to the communication apparatus 800 and that are configured to process a user plane function and/or a control plane function.

In another possible design, the communication apparatus 800 is a core network device configured to process a user plane function and/or a control plane function. The communication unit 801 is configured to receive a second configuration request message from a first network device, where the second configuration request message is used to configure a management and control operation of a sixth network device.

The communication unit 801 is further configured to send the second configuration request message to the sixth network device.

The communication unit 801 is further configured to receive a second configuration response message from the sixth network device, where the second configuration response message includes a response result of the sixth network device for the management and control operation.

The communication unit 801 is further configured to send the second configuration response message to the first network device.

The first network device is a core network device configured to control a network function; and the sixth network device is a radio access network device configured to provide a communication connection function between a terminal and a core network.

In some embodiments, the second configuration request message is used to configure a flow control operation of the sixth network device; and the second configuration response message includes a response result of the sixth network device for the flow control operation.

In some embodiments, the second configuration request message is used to configure a storage operation of the sixth network device for a backup relationship between a seventh network device and an eighth network device; the second configuration response message includes a response result of the sixth network device for the storage operation; and the seventh network device and the eighth network device are core network devices that are connected to the sixth network device and that are configured to process a user plane function and/or a control plane function.

This embodiment of this application is based on a same concept and brings same technical effects as the foregoing method embodiments. For a specific principle, refer to the descriptions of the foregoing embodiments. Details are not described again.

An embodiment of this application further provides a communication apparatus 900, as shown in FIG. 9. The communication apparatus 900 may be a first network device, a second network device, a fifth network device, or a sixth network device, may be a chip, a chip system, a processor, or the like that supports the first network device, the second network device, the fifth network device, or the sixth network device in implementing the foregoing method, or may be a chip, a chip system, a processor, or the like that supports a terminal device in implementing the foregoing method. The apparatus may be configured to implement the methods described in the foregoing method embodiments. For details, refer to the descriptions in the foregoing method embodiments.

The communication apparatus 900 may include at least one processor 901. The processor 901 may be a general-purpose processor, a dedicated processor, or the like. For example, the processor 901 may be a baseband processor, a digital signal processor, an application-specific integrated circuit, a field programmable gate array or another programmable logic device, a discrete gate or a transistor logic device, a discrete hardware component, or a central processing unit (CPU). The baseband processor may be configured to process a communication protocol and communication data. The central processing unit may be configured to control the communication apparatus (for example, a base station, a baseband chip, a terminal, a terminal chip, a distributed unit (DU), or a central unit (CU)), execute a software program, and process data of the software program.

Optionally, the communication apparatus 900 may include at least one memory 902. The memory 902 may store instructions 904, and the instructions may be run on the processor 901, to enable the communication apparatus 900 to perform the methods described in the foregoing method embodiments. Optionally, the memory 902 may further store data. The processor 901 and the memory 902 may be separately disposed, or may be integrated together.

The memory 902 may include but is not limited to a nonvolatile memory, for example, a hard disk drive (HDD) or a solid-state drive (SSD), a random access memory (RAM), an erasable programmable read-only memory (EPROM), a ROM, a compact disc read-only memory (CD-ROM), or the like.

Optionally, the communication apparatus 900 may further include an input/output interface 905. The input/output interface 905 may be referred to as a transceiver unit, a transceiver, a transceiver circuit, or the like, and is configured to implement receiving and sending functions. The input/output interface 905 may include an output interface and an input interface. The input interface may be configured to implement a receiving function, and the output interface may be configured to implement a sending function.

The communication apparatus 900 is the first network device: The input/output interface 905 is configured to perform S101 and S102 in the communication method 100 shown in FIG. 3, is configured to perform S201 and S202 in the communication method 200 shown in FIG. 4, and is configured to perform S301 and S304 in the communication method 300 shown in FIG. 5.

The communication apparatus 900 is the second network device: The input/output interface 905 is configured to perform S101 and S102 in the communication method shown in FIG. 3.

The communication apparatus 900 is the sixth network device: The input/output interface 905 is configured to perform S201 and S202 in the communication method 200 shown in FIG. 4, and is configured to perform S302 and S303 in the communication method 300 shown in FIG. 5.

The communication apparatus 900 is the fifth network device: The input/output interface 905 is configured to perform S301 to S304 in the communication method 300 shown in FIG. 5.

In another possible design, the processor 901 may include an input/output interface configured to implement receiving and sending functions. The input/output interface may be configured to read and write code/data, or the input/output interface may be configured to transmit or transfer a signal.

In still another possible design, optionally, the processor 901 may store instructions 903. When the instructions 903 are run on the processor 901, the communication apparatus 900 is enabled to perform the methods described in the foregoing method embodiments. The instructions 903 may be built into the processor 901. In this case, the processor 901 may be implemented by using hardware.

In still another possible design, the communication apparatus 900 may include a circuit. The circuit may implement a sending, receiving, or communication function in the foregoing method embodiments. The processor and the input/output interface that are described in this embodiment of this application may be implemented on an integrated circuit (IC), an analog IC, a radio frequency integrated circuit (RFIC), a mixed-signal IC, an application-specific integrated circuit (ASIC), a printed circuit board (PCB), an electronic device, or the like. The processor and the input/output interface may be alternatively manufactured by using various IC technologies, for example, a complementary metal oxide semiconductor (CMOS), an n-channel metal oxide semiconductor (NMOS), a p-channel metal oxide semiconductor (PMOS), a bipolar junction transistor (BJT), a bipolar CMOS (BiCMOS), silicon germanium (SiGe), and gallium arsenide (GaAs).

The communication apparatus described in the foregoing embodiments may be a network device or a terminal device. However, a scope of the communication apparatus described in embodiments of this application is not limited thereto, and a structure of the communication apparatus may not be limited by FIG. 9. The communication apparatus may be an independent device, or may be a part of a large device. For example, the communication apparatus may be:
(1) an independent integrated circuit IC, a chip, or a chip system or subsystem;
(2) a set having at least one IC, where optionally, the IC set may alternatively include a storage component configured to store data or instructions;
(3) an ASIC, such as a modem (modem);
(4) a module that can be embedded in another device;
(5) a receiver, a terminal, an intelligent terminal, a cellular phone, a wireless device, a handheld device, a mobile unit, a vehicle-mounted device, a network device, a cloud device, an artificial intelligence device, or the like; or
(6) others.

When the communication apparatus may be a chip or a chip system, refer to a diagram of a structure of a chip in FIG. 10. A chip 1000 shown in FIG. 10 includes a processor 1001 and an interface 1002. There may be at least one processor 1001, and there may be a plurality of interfaces 1002. The processor 1001 may be a logic circuit, and the interface 1002 may be an input/output interface, an input interface, or an output interface. The chip 1000 may further include a memory 1003.

In a design, the chip is configured to implement a function of a first network device in this embodiment of this application:

In some embodiments, the interface 1002 is configured to send a first configuration request message to a second network device, where the first configuration request message is used to configure a management and control operation of the second network device. The second network device is a core network device configured to process a user plane function and/or a control plane function.

The interface 1002 is further configured to receive a first configuration response message from the second network device, where the first configuration response message includes a response result of the second network device for the management and control operation.

In another optional implementation, the interface 1002 is configured to send a second configuration request message to a fifth network device or a sixth network device, where the second configuration request message is used to configure a management and control operation of the sixth network device. The fifth network device is a core network device configured to process a user plane function and/or a control plane function; and the sixth network device is a radio access network device configured to provide a communication connection function between a terminal and a core network.

The interface 1002 is further configured to receive a second configuration response message from the fifth network device or the sixth network device, where the second configuration response message includes a response result of the sixth network device for the management and control operation.

In another design, the chip is configured to implement a function of a second network device in this embodiment of this application:

The interface 1002 is configured to receive a first configuration request message from a first network device, where the first configuration request message is used to configure a management and control operation of the chip 1000. The first network device is a core network device configured to control a network function.

The interface 1002 is further configured to send a first configuration response message to the first network device, where the first configuration response message includes a response result of the chip 1000 for the management and control operation.

In another design, the chip is configured to implement a function of a sixth network device in this embodiment of this application:

The interface 1002 is configured to receive a second configuration request message from a first network device, or receive a second configuration request message from a first network device that is forwarded by a fifth network device, where the second configuration request message is used to configure a management and control operation of the chip 1000. The first network device is a core network device configured to control a network function; and the fifth network device is a core network device configured to process a user plane function and/or a control plane function.

The interface 1002 is further configured to send a second configuration response message to the first network device or the fifth network device, where the second configuration response message includes a response result of the chip 1000 for the management and control operation.

In another design, the chip is configured to implement a function of a fifth network device in this embodiment of this application:

The interface 1002 is configured to receive a second configuration request message from a first network device, where the second configuration request message is used to configure a management and control operation of a sixth network device.

The interface 1002 is further configured to send the second configuration request message to the sixth network device.

The interface 1002 is further configured to receive a second configuration response message from the sixth network device, where the second configuration response message includes a response result of the sixth network device for the management and control operation.

The interface 1002 is further configured to send the second configuration response message to the first network device.

The first network device is a core network device configured to control a network function; and the sixth network device is a radio access network device configured to provide a communication connection function between a terminal and a core network.

In embodiments of this application, the communication apparatus 900 and the chip 1000 may further perform the implementations of the communication apparatus 800. A person skilled in the art may further understand that various illustrative logical blocks (illustrative logic block) and steps (step) that are listed in embodiments of this application may be implemented by using electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation falls outside the protection scope of embodiments of this application.

This embodiment of this application is based on a same concept and brings same technical effects as the foregoing method embodiments. For a specific principle, refer to the descriptions in the foregoing method embodiments. Details are not described again.

A person skilled in the art may further understand that various illustrative logical blocks (illustrative logic block) and steps (step) that are listed in embodiments of this application may be implemented by using electronic hardware, computer software, or a combination thereof. Whether the functions are implemented by using hardware or software depends on particular applications and a design requirement of the entire system. A person skilled in the art may use various methods to implement the described functions for each particular application, but it should not be considered that the implementation falls outside the protection scope of embodiments of this application.

This application further provides a computer-readable storage medium, configured to store computer software instructions. When the instructions are executed by a communication apparatus, a function in any one of the foregoing method embodiments is implemented.

This application further provides a computer program product, configured to store computer software instructions. When the instructions are executed by a communication apparatus, a function in any one of the foregoing method embodiments is implemented.

This application further provides a computer program. When the computer program is run on a computer, a function in any one of the foregoing method embodiments is implemented.

All or some of the foregoing embodiments may be implemented by using software, hardware, firmware, or any combination thereof. When software is used to implement the foregoing embodiments, all or some of the foregoing embodiments may be implemented in a form of a computer program product. The computer program product includes at least one computer instruction. When the computer instruction is loaded and executed on a computer, all or some of the procedures or functions according to embodiments of this application are generated. The computer may be a general-purpose computer, a dedicated computer, a computer network, or another programmable apparatus. The computer instruction may be stored in a computer-readable storage medium or may be transmitted from a computer-readable storage medium to another computer-readable storage medium. For example, the computer instruction may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, for example, a server or a data center, integrating at least one usable medium. The usable medium may be a magnetic medium (for example, a floppy disk, a hard disk drive, or a magnetic tape), an optical medium (for example, a high-density digital video disc (DVD)), a semiconductor medium (for example, an SSD), or the like.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A communication method, comprising:
sending, by a first network device, a first configuration request message to a second network device, wherein the first configuration request message is useable to configure a management and control operation of the second network device, wherein
the first network device is a core network device configured to control a network function; and
the second network device is the core network device configured to process at least one of a user plane function or a control plane function; and
receiving, by the first network device, a first configuration response message from the second network device, wherein the first configuration response message comprises a first response result of the second network device for the management and control operation.

2. The method according to claim 1, wherein
the first network device is configured to maintain a topology relationship of the core network device; and
before the sending, by the first network device, the first configuration request message to the second network device, the method further comprises:
determining, by the first network device, the first configuration request message based on a running status of the core network device in the topology relationship.

3. The method according to claim 1, wherein
the first configuration request message is useable to configure a flow control operation of the second network device; and
the first configuration response message comprises a second response result of the second network device for the flow control operation.

4. The method according to claim 1, wherein
the first configuration request message is useable to configure a backup operation of the second network device for a user context of a third network device;
the first configuration response message comprises a second response result of the second network device for the backup operation; and
the third network device is the core network device configured to process at least one of a user plane function or a control plane function.

5. A communication method, comprising:
receiving, by a second network device, a first configuration request message from a first network device, wherein the first configuration request message is useable to configure a management and control operation of the second network device, wherein
the first network device is a core network device configured to control a network function; and
the second network device is the core network device configured to process at least one of a user plane function or a control plane function; and
sending, by the second network device, a first configuration response message to the first network device, wherein the first configuration response message comprises a first response result of the second network device for the management and control operation.

6. The method according to claim 5, wherein
determining, by the second network device, the first configuration response message based on the first configuration request message and one of a first message from a fourth network device or a network management system;
the first message is useable to configure the management and control operation of the second network device, and a type of the management and control operation configured by the first message is the same as a type of the management and control operation configured by the first configuration request message; and
the fourth network device is a radio access network device configured to provide a communication connection function between a terminal and the core network.

7. The method according to claim 6, wherein a priority of the first configuration request message is higher than a priority of the first message, and the first response result is an acknowledgment of the second network device for the management and control operation configured by the first configuration request message.

8. The method according to claim 5, wherein
the first configuration request message is useable to configure a flow control operation of the second network device; and
the first configuration response message comprises a second response result of the second network device for the flow control operation.

9. The method according to claim 5, wherein
the first configuration request message is useable to configure a backup operation of the second network device for a user context of a third network device;
the first configuration response message comprises a second response result of the second network device for the backup operation; and
the third network device is a core network device configured to process at least one of a user plane function or a control plane function.

10. A communication method comprising:
sending, by a first network device, a second configuration request message to a fifth network device or a sixth network device, wherein the second configuration request message is useable to configure a management and control operation of the sixth network device, wherein
the first network device is a core network device configured to control a network function;
the fifth network device is the core network device configured to process at least one of a user plane function or a control plane function; and
the sixth network device is a radio access network device configured to provide a communication connection function between a terminal and the core network; and
receiving, by the first network device, a second configuration response message from the fifth network device or the sixth network device, wherein the second configuration response message comprises a first response result of the sixth network device for the management and control operation.

11. The method according to claim 10, wherein
the first network device is configured to maintain at least one of a topology relationship of the core network device or a topology relationship of a radio access network device; and
before the sending, by the first network device, the second configuration request message to the fifth network device or the sixth network device, the method further comprises:
determining, by the first network device, the second configuration request message based on at least one of a running status of the core network device in the topology relationship or a running status of the radio access network device in the topology relationship.

12. The method according to claim 10, wherein
the second configuration request message is useable to configure a flow control operation of the sixth network device; and
the second configuration response message comprises a second response result of the sixth network device for the flow control operation.

13. The method according to claim 10, wherein
the second configuration request message is useable to configure a storage operation of the sixth network device for a backup relationship between a seventh network device and an eighth network device;
the second configuration response message comprises a second response result of the sixth network device for the storage operation; and
the seventh network device and the eighth network device are core network devices that are connected to the sixth network device and that are configured to process at least one of a user plane function or a control plane function.

14. A communication method comprising:
receiving, by a sixth network device, a second configuration request message from a first network device, or receiving, by the sixth network device, the second configuration request message from the first network device that is forwarded by a fifth network device, wherein the second configuration request message is useable to configure a management and control operation of the sixth network device, wherein
the first network device is a core network device configured to control a network function;
the fifth network device is the core network device configured to process at least one of a user plane function or a control plane function; and
the sixth network device is a radio access network device configured to provide a communication connection function between a terminal and the core network; and
sending, by the sixth network device, a second configuration response message to one of the first network device or the fifth network device, wherein the second configuration response message comprises a first response result of the sixth network device for the management and control operation.

15. The method according to claim 14, wherein
determining, by the sixth network device, the second configuration response message based on the second configuration request message and a second message from a ninth network device or a network management system;
the second message is useable to configure the management and control operation of the sixth network device, and a type of the management and control operation configured by the second message is the same as a type of the management and control operation configured by the second configuration request message; and
the ninth network device is the core network device configured to process at least one of a user plane function or a control plane function.

16. The method according to claim 15, wherein a priority of the second configuration request message is higher than a priority of the second message, and the first response result is an acknowledgment of the sixth network device for the management and control operation configured by the second configuration request message.

17. The method according to claim 14, wherein
the second configuration request message is useable to configure a flow control operation of the sixth network device; and
the second configuration response message comprises a second response result of the sixth network device for the flow control operation.

18. The method according to claim 14, wherein
the second configuration request message is useable to configure a storage operation of the sixth network device for a backup relationship between a seventh network device and an eighth network device;
the second configuration response message comprises a second response result of the sixth network device for the storage operation; and
the seventh network device and the eighth network device are core network devices that are connected to the sixth network device and that are configured to process at least one of a user plane function or a control plane function.

19. A communication method, comprising:
receiving, by a fifth network device, a second configuration request message from a first network device, wherein the second configuration request message is useable to configure a management and control operation of a sixth network device;
sending, by the fifth network device, the second configuration request message to the sixth network device;
receiving, by the fifth network device, a second configuration response message from the sixth network device, wherein the second configuration response message comprises a first response result of the sixth network device for the management and control operation; and
sending, by the fifth network device, the second configuration response message to the first network device, wherein
the first network device is a core network device configured to control a network function;
the fifth network device is the core network device configured to process at least one of a user plane function or a control plane function; and
the sixth network device is a radio access network device configured to provide a communication connection function between a terminal and the core network.

20. The method according to claim 19, wherein
the second configuration request message is useable to configure a flow control operation of the sixth network device; and
the second configuration response message comprises a second response result of the sixth network device for the flow control operation.
